(19) United States
(12) Patent Application Publication
(10) Pub. No.: US 2013/0062469 A1
(43) Pub. Date: Mar. 14, 2013

(54) SURFACE ENTITY FOR THE REDUCTION OF THE AIR RESISTANCE OF AN AVIATION VEHICLE

(71) Applicants: Metin Cengiz, Bielefeld (DE); Freerk Syassen, Stadland (DE)

(72) Inventors: Metin Cengiz, Bielefeld (DE); Freerk Syassen, Stadland (DE)

(73) Assignee: AIRBUS OPERATIONS GMBH, Hamburg (DE)

(21) Appl. No.: 13/635,488

(22) PCT Filed: Mar. 16, 2011
(86) PCT No.: PCT/EP11/54010

§ 371 Date: Nov. 14, 2012

Related U.S. Application Data
(62) Division of application No. 61/314,594, filed on Mar. 17, 2010.

(30) Foreign Application Priority Data
Mar. 17, 2010 (DE) 102010011750.1

(51) Int. Cl. B64C 21/10

(52) U.S. Cl. 244/130

(57) ABSTRACT

The invention concerns a surface entity for the reduction of the air resistance of an aviation vehicle, in particular an aircraft.

In accordance with the invention the surface entity is formed with at least one metal wire arrangement, in particular with a metal mesh and/or a composite mesh, which can be arranged in at least some sections in the region of at least one surface of the aviation vehicle immersed in the flow, in particular can be adhesively bonded and/or clamped onto the latter, wherein the metal wire arrangement has a ribbed structure with a multiplicity of ribs running essentially parallel to one another.

As a consequence of the multiplicity of ribs running parallel to the flow direction, the arrangement of which can be compared with the structure of the sharkskin of known art, there ensues a reduction of the flow resistance of the surface on or over which the air flows of between 3% and 10%, as a result of which a significant fuel saving potential ensues in flight operations. In comparison to polymer films of prior known art with a surface structure similar to that of the sharkskin a significantly higher resistance to erosion ensues. The metal wire arrangement can be formed with a metal mesh and/or with a composite mesh thermally joined at the crossing points.

The invention concerns a surface entity for the reduction of the air resistance of an aviation vehicle, in particular an aircraft.

In the field of flow mechanics it is of known art to reduce the flow resistance that a liquid or a gaseous medium presents to an object that is moving in the latter, by means of surfaces that are roughened, in at least some regions.

An example of known art for this is the skin of a shark, which enables the shark to achieve high speeds in water with a relatively low expenditure of energy. In order to effect this the sharkskin has a multiplicity of microscopically small grooves, which are preferably arranged on the sharkskin in the flow direction of the water, spaced apart in parallel to one another. In recent times technical replications of the sharkskin structure are of known art; these are based on polymer films, the fine structure of which is comparable with the surface topography of the sharkskin, and are being deployed in aviation. In particular the microscopically small grooves of the synthetic replication of the sharkskin prevent the transverse movements of air vortices near the boundary layer, and by this means reduce the flow resistance in the air of an aircraft equipped in this manner.

Here theoretical deliberations envisage a possible reduction of the flow resistance by up to 10%. Practical tests with such polymer films installed on lifting surfaces and other surfaces of an aircraft have resulted in a detectable reduction of flow resistance of up to 3%. The main disadvantage of the polymer replications of prior known art of the sharkskin structure, of known art from nature, lies in their low maintainability and the low service life that is engendered by the latter. Extreme weather conditions, such as for example strong solar radiation, high temperatures and cold, cause the films to age quickly. As a consequence of erosion effects, which are brought about as a result of incident dust, dirt, ice, or sand particles in the air, the sharkskin films wear out very quickly in flight, and as a result lose their effectiveness, at least in part. All of the cited effects require frequent replacement of the applied polymer films; in the light of the high maintenance costs this is not acceptable.

From EP 1 176 088 A1 a lifting arrangement for aircraft is of known art, in which a multiplicity of groove-type structures are provided, laterally arranged on the fuselage; in each case these are arranged spaced apart parallel to one another. The grooves run inclined at an angle of incidence of a few degrees to the airflow, in order to generate the desired lifting force. However, as a consequence of the inclined ribs the air resistance inevitably increases, since otherwise no effective lifting force would be produced.

EP 0 284 187 A1 discloses a technical implementation of a surface structure similar to that of a sharkskin for purposes of influencing the boundary layer of a surface immersed in a flow using so-called “riblets” to achieve a reduction of the flow resistance.

DE 102 13 445 A1 has as its subject a lowering of air resistance with the utilisation of turbulence. By the attachment of meshes onto a surface immersed in a flow, in at least some regions, turbulence is generated in a targeted manner, which is designed to lead to a reduction of the air resistance. In contrast to this the sharkskin effect is based just on a suppression of the transverse movements of vortices in the boundary layer region between the airflow and the surface immersed in the flow by means of small ribbed structures (so-called “riblets”).

The object of the invention is to create a surface entity, the surface structure of which approximates to that of a sharkskin, and which at the same time has a high resistance to wear and thus a long service life.

This object is achieved by means of a surface entity in accordance with Claim 1.

In that the surface entity is at least one metal wire arrangement, in particular a metal mesh and/or a composite mesh, which in at least some sections can be arranged in the region of at least one surface immersed in the flow of the aviation vehicle, in particular which can be adhesively bonded and/or clamped onto the latter, wherein the metal wire arrangement has a ribbed structure with a multiplicity of ribs running essentially parallel to one another, the surface entity enables a significant reduction of the air resistance by virtue of the so-called “sharkskin effect” with, at the same time, a high resistance to wear.

Moreover the surface entity improves the erosion resistance of the surface areas of the aircraft that are aerodynamically highly loaded, in particular in the region of the wing leading edges, the elevator unit leading edges, and the vertical tail unit leading edge. In addition improved protection from intensive solar radiation ensues as a result of the deployment of the surface entity; in particular this leads to an increase in the service life of adhesively bonded joints in the sector of CFRP components, GRP components, metal-fibre laminates, such as Glare®, by reducing the surface temperature.

The metal wire arrangement can be arranged on the surface immersed in the flow, that is to say, it can be adhesively bonded and/or clamped onto the latter. Alternatively the metal wire arrangement can in at least some regions, terminate flush with the surface immersed in the flow, and/or can connect to the latter. In this case the surface has regions of depression, the depth of which corresponds to a material thickness of the surface entity plus the depth of an adhesive layer that is required in the case of attachment with the aid of adhesive, if the surface entity is adhesively bonded. The term “surface immersed in the flow” defines the whole surface of the aircraft, including the active aerodynamic surfaces, such as for example, lifting surfaces, elevator unit and vertical tail unit.

In order to increase further the effect of the metal wire arrangement in reducing the air resistance, suction equipment can be provided, by means of which a reduced pressure relative to ambient air pressure can be generated and maintained at a predefined value in the region of the metal wire arrangement. The metal wire arrangement is preferably formed from a metal mesh consisting of alternating warp wires and weft wires preferably crossing at an angle of approximately 90°, that is to say, metallic wires that are interwoven. Crossing angles of between 30° and 90° are similarly possible.

Alternatively the metal wire arrangement can be also embodied as a so-called composite mesh, i.e. a thermally-joined “metal wire mat”. Here a first layer, i.e. plane, is formed from a multiplicity of longitudinal wires spaced apart and running approximately parallel to one another. A further layer is manufactured with transverse wires similarly arranged approximately parallel to one another; these are preferably laid down at an angle of 90° onto the longitudinal wires that are located underneath, that is to say, without being interwoven with the latter. At the ensuing crossing points the longitudinal and transverse wires are in each case thermally joined; this can be undertaken, for example, by means of diffusion brazing. To achieve a desired material thickness for the surface entity an appropriate number of layers, i.e. planes, with longitudinal and transverse wires are layered one above another. The advantage of this composite mesh lies in the fact, amongst others, that continuous ribbed structures—such as are advantageously finding application for reducing the air resistance utilising the “sharkskin effect”—can be manufactured in longer lengths, and the wires in each layer, i.e. plane, can assume different spacings from one another as required. Furthermore the diameters of the individual wires can in each case be selected to be of differing sizes for purposes of optimising the aerodynamically effective structure by regions. In order to hold the level of manufacturing complexity within bounds, the wire diameters in at least each layer can be designed to be of equal size.

In accordance with an advantageous further development of the device provision is made that the ribs have in each case a height of between 10 μm and 1 mm, and a width between of 10 μm and 1 mm, and in each case are aligned essentially parallel to one another with a spacing of between 10 μm and 1 mm.

As a consequence of the ranges of rib dimensions cited the transverse movements of vortices on the surface are suppressed such that a reduction of the air resistance of up to 3% ensues. A cross-sectional geometry of the wires forming, i.e. approximating to, the ribs (weft wires and/or warp wires, i.e. longitudinal and transverse wires) can deviate from the circular form, and can, for example, be approximately square, rectangular, triangular, diamond-shaped, trapezoidal-shaped, semicircular shaped, semi-elliptical, or also half-oval, so as to increase further the effect of the surface entity in reducing flow resistance.

In accordance with a further form of embodiment the metal wire arrangement, in particular in the region of surfaces immersed in the flow that are only slightly electrically conducting, in particular surfaces of CFRP components, is arranged for purposes of reducing air resistance and for purposes of lightning protection, for purposes of electromagnetic shielding, and/or for purposes of providing a return path to earth.

By this means the copper mesh, which is otherwise as a rule integrated into the resin matrix when using CFRP components for purposes of lightning protection and/or electrical shielding, can at least partly be replaced, so that in addition to the reduction of air resistance a weight reduction also ensues. Moreover the electrically conducting surface entity in individual cases can also make the separate earth return lines, which as a rule are always necessary when using CFRP components, partly superfluous, and can thus contribute to further weight reductions.

In a further configuration of the surface entity, provision is made that the metal wire arrangement is arranged in the region of the surface immersed in the flow such that the ribs are aligned, in at least some sections, parallel to a local orientation of the airflow.

As a consequence of this orientation of the ribbed structure to the incident airflow the greatest possible reduction of air resistance ensues, since any transverse movements of local vortices in the vicinity of the boundary layer are very largely suppressed by the ribs of the metal wire arrangement.

In accordance with a further development of the surface entity the metal wire arrangement is a metal mesh, wherein the metal mesh is formed from a multiplicity of interwoven wires of a stainless steel alloy, in particular a chrome-nickel alloy, and/or with wires of a titanium alloy.

The configuration of the surface entity as a metal mesh with interwoven wires makes cost-effective manufacture possible, at the same time with a metal mesh surface structure that can be reproduced with a high level of accuracy. The build up of the metal mesh with warp wires and weft wires, which preferably cross alternately at angles of approximately 90°, allows recourse to mature methods of textile production of known art, and to production facilities, which allow the manufacture of a large range of a very wide variety of spatial structures with various surface geometries. The deployment of meshes that are formed from a stainless steel alloy or a titanium alloy enables a high corrosion resistance. The deployment of titanium wires moreover enables a further weight reduction. Alternatively the metal wire arrangement can be built up, in at least some regions, with the composite mesh already described in the introduction, whose longitudinal and transverse wires are thermally joined at the crossing points. In accordance with a further advantageous development of the surface entity, the metal mesh is embodied in at least some regions as a so-called “five shaft mesh”.

By this means the resulting surface geometry is a particularly effective approximation to the model provided by the microstructure of the sharkskin.

In a further advantageous development of the surface entity, provision is made that the metal mesh in at least some regions is a smooth Dutch weave mesh.

As a consequence of this configuration a good approximation of the surface geometry is on the one hand obtained to the desired structure of the sharkskin that is being imitated. On the other hand, in a simple Dutch weave mesh through the weaving in of one or two additional weft wires, which in each case run transverse at an angle of approximately 90° to the perpendicular warp wires of the metal mesh (a so-called duplex or triplex Dutch weave mesh) the aerodynamically effective length of the ribs can be increased in a simple manner.

In accordance with a further configuration of the surface entity the wires of the metal wire arrangement have a diameter of between 10 μm and 1 mm.

The intervals cited for the diameters of the metal wires to be deployed allow an optimal adaptation of the inventive surface entity to the aerodynamic conditions prevailing in flight, so as to achieve as effective a reduction of air resistance as possible.

### IN THE DRAWINGS

FIG. 1 shows a schematic plan view onto a first variant of embodiment of the inventive surface entity using a so-called “five shaft metal mesh”.

FIG. 2 shows a second variant of embodiment of the surface entity deploying a so-called “smooth” (simple) Dutch weave metal mesh, and

FIG. 3 shows a schematic cross-sectional representation through the surface entity in accordance with FIG. 2.

In the drawings the same design elements have the same reference numbers in each case.

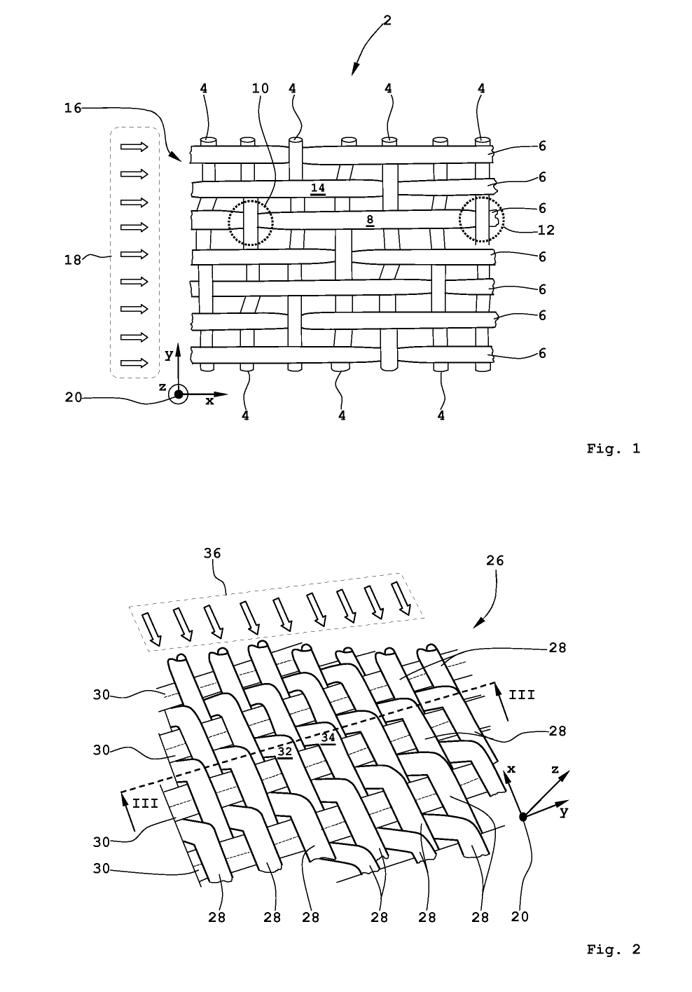

FIG. 1 is a plan view illustrating the principle of a first variant of embodiment of the surface entity with a metallic “five shaft mesh”.

A surface entity 2 is formed from a multiplicity of metallic wires interwoven in each case; these wires preferably have the same diameter. Here a multiplicity of warp wires 4 are arranged in the vertical direction and a multiplicity of weft wires 6 are arranged in the horizontal direction, in each case running alternately over and under one another at an angle of 90°. A coordinates system with an x-axis, a y-axis and a z-axis, illustrates the location of the surface entity 2 and the wires in space.

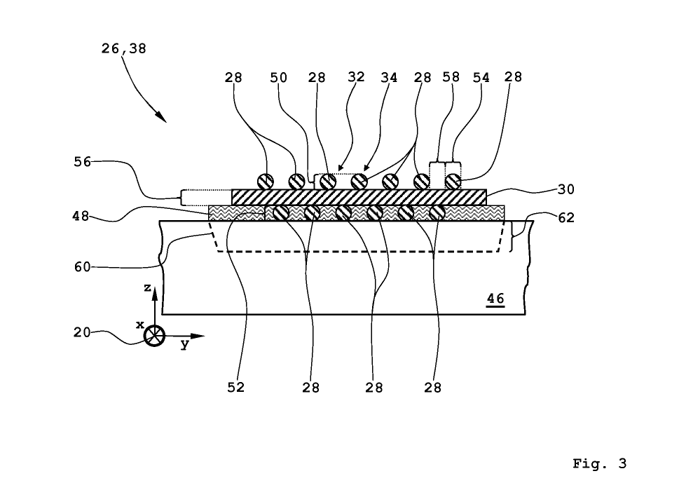

The surface entity 2 shown takes the form of a so-called “five shaft mesh”, since in the region of a rib 8 in a crossing region 10 a warp wire 4 runs above a weft wire 6, whereas the four adjacent warp wires 4, running spaced apart on the right-hand side, run underneath the weft wire 6, and a fifth warp wire 4 is only arranged above the weft wire 6 once again in a crossing region 12. The rib 8, a rib 14, and all other ribs, not provided with a reference number, approximate in their totality to a ribbed structure 16, which in terms of its fluid mechanical, i.e. aerodynamic, effect can be equated with the microscopic sharkskin structure of known art from biology, and which effects a reduction of the flow resistance of the air of between 3% and 10%—compared with a completely smooth surface. As a result the fuel consumption of the aircraft is reduced, so that either the range or the payload can be increased. A laminar airflow 18, which impinges onto the surface entity 2, is indicated by a multiplicity of white arrows. As can be seen from the representation in FIG. 2, the airflow 18 runs essentially parallel to the orientation of the two ribs 8, 14 and of the other ribs, i.e. parallel to the x-axis of the coordinates system 20. The effect of all the ribs is based essentially on the fact that in a thin boundary layer region (10 μm to 1 mm) above the surface entity 2 transverse movements of air vortices parallel to the direction of the warp wires 4 are very largely suppressed.

The weft and warp wires 4, 6 of the metallic surface entity 2 preferably have in each case a circular cross-sectional geometry with a diameter of between 10 μm and 1 mm, wherein the diameters of the wires are preferably selected to be equal. In individual cases the diameters of the wires can also be up to 1 mm. In a deviation from the above, cross-sectional geometries with three or more corners are possible for the wires, as are oval or elliptical cross-sectional geometries. The weft and warp wires 4, 6 are preferably manufactured from a chrome-nickel-steel alloy and/or a titanium alloy, so as to ensure sufficient corrosion resistance.

By virtue of the good electrical conductivity of the metal surface entity 2 in comparison to CFRP components, the metal surface entity 2, in particular when applied to CFRP or GFRP components, in addition to reducing air resistance can also fulfil lightning protection tasks. Moreover it can at least in part undertake the function of an earth return path and/or that of an electrical shield against electromagnetic interference fields, as a result of which, since earth lines are no longer required, a further weight saving potential for the aircraft ensues. Moreover the inventive surface entity 2 improves the erosion resistance of regions of the aircraft outer surface that are particularly highly loaded aerodynamically, such as, for example, the lifting surface leading edges, the elevator unit leading edges, or the vertical tail unit leading edge. Finally the surface entity 2 improves the service life of CFRP components significantly, since local overheating, which for example can rapidly occur as a result of intensive solar radiation, is very largely avoided as a result of the good thermal conductivity of the surface entity 2 and the evening out of thermal effects that is engendered by this means.

FIG. 2 shows a second variant of embodiment of the surface entity deploying a so-called “smooth (plain) metallic Dutch weave mesh”.

A surface entity 26 is formed from a multiplicity of warp wires 28 and weft wires 30, in each case crossing at an angle of approximately 90°. Since in each case only one weft wire 30 runs underneath the warp wires 28 this takes the form of a so-called plain “smooth Dutch weave mesh”. The warp wires 28 form a multiplicity of ribs 32, 34, of which only two are provided with a reference number in the interests of better clarity in the drawing. The ribs 32, 34 run approximately parallel to an airflow 36 and by this means approximate to a ribbed structure with a surface geometry that can be compared with the surface geometry of a sharkskin. By this means the desired reduction of air resistance by between 3% and 10% ensues. In order to increase in each case the aerodynamically effective length of the ribs above the weft wires 30, it is possible, in a variation from the representation in FIG. 2, to allow more than one weft wire 30 to run underneath each rib 32, 34 If the number of wires 30 deployed is, for example, doubled, as indicated by the dashed lines with a small dash length, then a so-called “smooth duplex Dutch weave mesh” is obtained. If three weft wires 30 run underneath each rib, for example, the mesh takes the form of a so-called “smooth triplex Dutch weave mesh”. Alternatively it is possible, instead of increasing the number of weft wires 30 underneath each rib, to increase their diameter and/or to configure their cross-sectional geometry in a manner deviating from a circular geometry.

To increase the effective length of the ribs in terms of their fluid mechanics, weft wires 30 with an essentially rectangular or oval geometry can be deployed, for example, in the surface entity 26, wherein a height of the cross-sectional geometry in the z-direction is preferably selected to be at least slightly smaller than its longitudinal extent in the x-direction. In order to optimise further the properties of the surface entity 26 in terms of reducing air resistance, it can furthermore also be advantageous to use warp wires 28 in the surface entity with a cross-sectional geometry deviating from a circular shape. For example the warp wires 28 can similarly have a rectangular or an oval cross-sectional geometry, wherein their height in the z-direction is preferably selected to be at least slightly larger than their width in the y-direction, in order to increase in particular the effective aerodynamic height of the ribs in real terms.

With regard to the metal wires deployed in the formation of the metal mesh shown in FIG. 2 reference should be made to the remarks in the description of FIG. 1 regarding the geometrical configuration and the material composition of the wires.

In a deviation from the exemplary metal meshes illustrated in FIGS. 1, 2 a multiplicity of further types of weaves of known art from textile engineering can be deployed in the creation of the inventive surface entity 2, 26. As explained in the introduction, the surface entity 2, 26 can, at least in some regions, be formed with a non-woven “composite mesh”, which is, for example, diffusion brazed, the various layers of which, with longitudinal and transverse wires running in each case parallel to one another and spaced apart, are brazed or welded with one another at each of the crossing points.

FIG. 3 shows a simplified cross-sectional representation through the metal mesh of the surface entity in accordance with FIG. 2 along a weft wire.

The surface entity 26 is applied by means of an adhesive layer 48 to the full surface area of a surface 46 immersed in the flow. The warp wires 28 in each case run perpendicular to the plane of the drawing. A height 50 of the ribs 32, 34 lies in a range between 10 μm and 1 mm, and in the example of embodiment shown in FIG. 3 corresponds in each case to a diameter 52 of the warp wires 28. A width 54 of the ribs lies similarly in a range between 10 μm and 1 mm, and here corresponds, again in order to simplify the representation in the drawing, to the diameter of the warp wires 28, and to a diameter 56 of the weft wires 30. In this example of embodiment a spacing 58 also corresponds to the diameters 52, 56 of the warp wires 28 and the weft wires 30. In the example of embodiment shown a material thickness, not provided with a reference number, of the adhesive layer 48 likewise corresponds to the diameter 52 of the warp wires 28 and the diameter 56 of the weft wires 30, so that the warp wires 28 are completely embedded into the adhesive layer 48.

In a deviation from the dimensional simplifications undertaken in FIG. 3 with regard to the diameters of the wires 28, 30 and the spacings of the ribs 32, 34 from one another, the dimensions of the design elements cited can be freely varied as a function of the aerodynamic, i.e. flow, conditions in an interval between 10 μm and 1 mm, and if required can also be selected to be different in each case. Moreover the cross-sectional geometry can, as already presented in the context of the description of FIG. 1, deviate from a circular geometry.

In order to achieve a flush finish of the surface entity 26 with the surface 46 immersed in the flow, a depression 60 can be provided. A depth 62, i.e. height, of the depression preferably corresponds to twice the diameter 52, 56 of the warp wires 28 or weft wires 30 deployed, so that in this configuration only the ribs 32, 34 continue to protrude above the surface 46 immersed in the flow.

Alternatively the metal mesh of the surface entity 26 can also be clamped onto the surface 46 immersed in the flow and/or clamped within a depression of the surface immersed in the flow. For this purpose suitable clamping strips, clamping frames or clamping grooves are provided, with which the final fixing of the location of the surface entity 26 is undertaken, if necessary flush with the surface 46 immersed in the flow.

### REFERENCE SYMBOL LIST

2 Surface entity
4 Warp wire
6 Weft wire
8 Rib
10 Crossing region
12 Crossing region
14 Rib
16 Ribbed structure
18 Airflow
20 Coordinates system
26 Surface entity
28 Warp wire
30 Weft wire
32 Rib
34 Rib
36 Airflow
38 Ribbed structure
46 Surface immersed in the flow
48 Adhesive layer
50 Height (rib)
52 Diameter (warp wire)
54 Width (rib)
56 Diameter (weft wire)
58 Spacing (rib)
60 Depression
62 Depth (depression)

1. A surface entity (2, 26) for the reduction of the air resistance of an aviation vehicle, in particular an aircraft, characterised in that, the surface entity (2, 26) is at least one metal wire arrangement, in particular a metal mesh and/or a composite mesh, which can be arranged in at least some sections in the region of at least one surface (46) of the aviation vehicle immersed in the flow, in particular can be adhesively bonded and/or clamped onto the latter, wherein the metal wire arrangement has a ribbed structure (16, 38) with a multiplicity of ribs (8, 14, 32, 34) running essentially parallel to one another.

2. The surface entity in accordance with claim 1, characterised in that, the ribs (8, 14, 32, 34) in each case have a height of between 10 μm and 1 mm, a width of between 10 μm and 1 mm, and in each case are aligned essentially parallel to one another with a spacing of between 10 μm and 1 mm.

3. The surface entity in accordance with claim 1, characterised in that, the metal wire arrangement, in particular in the region of only slightly electrically conducting surfaces immersed in the flow, in particular in the region of CFRP components, is arranged for purposes of reducing air resistance and for purposes of lightning protection, for purposes of electromagnetic shielding and/or for purposes of providing a return path to earth.

4. The surface entity in accordance with claim 1, characterised in that, the metal wire arrangement is arranged in the region of the surface (46) immersed in the flow such that the ribs (8, 14, 32, 34) are aligned, in at least some sections, parallel to a local orientation of an airflow.

5. The surface entity in accordance with claim 1, characterised in that, the metal wire arrangement is a metal mesh, wherein the metal mesh is formed from a multiplicity of interwoven wires of a chrome-nickel-steel alloy, and/or with wires of a titanium alloy.

6. The surface entity in accordance with claim 5, characterised in that, the metal mesh in at least some regions is a five shaft mesh.

7. The surface entity in accordance with claim 5, characterised in that, the metal mesh in at least some regions is a smooth Dutch weave mesh.

8. The surface entity in accordance with claim 7, characterised in that, the metal mesh in at least some regions is a smooth duplex or triplex Dutch weave mesh.

9. The surface entity in accordance with claim 1, characterised in that, the wires of the metal wire arrangement have a diameter of between 10 μm and 1 mm.
